(19) United States
(12) Patent Application Publication
(10) Pub. No.: US 2003/0177041 A1
(43) Pub. Date: Sep. 18, 2003

(54) Systems and methods for creating and online viewing of pathology reports

(76) Inventors: Hansel Brady Millican III, Lakeland, FL (US); Thomas Lee Stagner, Lake Worth, FL (US); Brian Christopher Nerzig, Miami Lakes, FL (US); Daniel James Polanec, Coral Springs, FL (US); Medhat Mostafa Saleh, Lewisville, TX (US); Sherry Rae Larson, Orlando, FL (US)

Correspondence Address: ALSTON & BIRD LLP, BANK OF AMERICA PLAZA, 101 SOUTH TRYON STREET, SUITE 4000, CHARLOTTE, NC, 28280-4000, US

(21) Appl. No.: 10/098,751

(22) Filed: Mar. 15, 2002

(51) Int. Cl. G06F 17/60

(52) U.S. Cl. 705/3

(57) ABSTRACT

The present invention provides systems and methods for the generation, online viewing and display of the level of significance, and printing of reports created by the analysis and diagnosis of tissue and organ specimens provided to pathology laboratories by client/physicians. These reports graphically indicate the site, severity and diagnosis of the specimen and include textual analysis, diagnosis and treatment information. The present invention also relates to systems and methods for the generation, online viewing and printing of diagnostic fact sheets that are related to the site, severity and diagnosis of a specimen and to systems and methods for the generation, online viewing and printing of requisitions for the analysis and diagnosis of a specimen by a pathologist.

### FIELD OF THE INVENTION

The present invention generally relates to pathology reports, and particularly to the creation of pathology reports that may be viewed online.

### BACKGROUND OF THE INVENTION

Physicians rely upon pathology laboratories to provide accurate and timely diagnostic reports on tissue samples of the physician's patients. Presently, such reports are generated and printed at the laboratory and faxed, mailed or delivered by courier to the requesting physician. A diagnostic fact sheet is sometimes provided to the physician with the diagnostic report. The diagnostic fact sheet typically provides explanatory information pertaining to the diagnosis and possible treatments. Illustrative of a system for automatically generating diagnostic fact sheets is U.S. Pat. No. 5,991,729 to Barry et al. (hereafter, the '729 patent).

The '729 patent teaches assigning diagnostic codes to common diagnoses and storing the codes with standard archived textual and graphical information associated with the diagnoses in a relational database. The '729 patent compiles a diagnostic fact sheet by associating a patient identifier with a diagnostic code so that the report includes the standard archived textual and graphical information and patient information. The '729 patent; however, describes a system where the diagnostic fact sheet must be printed and faxed, couriered, or mailed to the physician or the diagnostic fact sheet may be sent by modem. The system described in the '729 patent does not provide a complete pathology report comprised of patient, physician, laboratory, pathologist, diagnosis, patient-specific textual and graphic information. It provides only archived textual and graphical information related to a diagnosis.

### SUMMARY OF THE INVENTION

In summary, the present invention provides systems and methods for the generation, online viewing, online severity indication, online sorting, and printing of pathology reports created by the analysis and diagnosis of tissue and organ specimens provided to pathology laboratories by client/physicians. The present invention also provides the automatic determination of a diagnostic fact sheet by the specialty of the laboratory/pathologist performing the analysis, site of the specimen, and the severity of the diagnosis; the online viewing of the diagnostic fact sheet, and the ability of the client/physician to print the diagnostic fact sheet for presentation to a patient. The present invention further provides auto-population of an online auto-requisition system with client/physician and patient information, the online viewing of the requisition, and the printing of the requisition by the client/physician.

The present invention is an advancement over the use of merely a diagnostic code associated with standard archival textual and graphical information in providing pathology analysis information to a client/physician and/or patient. The present invention provides specimen-specific site, diagnosis, and severity of diagnosis information in pathology reports that may be viewed and manipulated on-line through a web-based browser thus providing the client/physician with comprehensive, accessible, maintainable and manipulable information. It provides an automatically-generated pathology report that has not only patient, physician, laboratory, pathologist, specimen, and diagnosis information, but also provides patient-specific textual and graphic information, and a physiological system graphic on the report that visually indicates the location from which the specimen was obtained and the severity of the diagnosis of the specimen. A client/physician may easily access the pathology reports associated with the specimens of the client/physician's patients via a web-based browser where a visual level of significance indicator allows the client/physician to rapidly discern those specimens that may need the most urgent attention. The on-line viewing feature also indicates which reports may have already been reviewed by the client/physician and allows the client/physician the ability to sort and manipulate the information and reports. Furthermore, the present invention facilitates record-keeping in that the reports may be archived and can be retrieved from the archives if needed.

In addition to the specimen (and patient) specific pathology report, another feature of the present invention is the automatic determination of a diagnostic fact sheet that is chosen based upon the specialty of the laboratory/pathologist, the site of the specimen, and the severity of the diagnosis of the specimen. The client/physician may provide the diagnostic fact sheet to a patient to facilitate the patient's understanding of a diagnosis and any treatment options available to the patient.

Yet another feature of the present invention is its ability to automatically generate a requisition to a pathology laboratory for additional pathological tests on a specimen or tests on another specimen. The auto-requisition feature can automatically populate the requisition with information about the client/physician requesting the test such as the client/physician's name and address, and also with information about the patient, such as the patient's name, address and social security number.

In accordance with an aspect of the present invention, a client/physician provides a patient's tissue or organ specimen to a laboratory for analysis and diagnosis. Information concerning the specimen that has been received by a laboratory is entered into a laboratory information system (“LIS”), which is an application that resides on a server and stores the entered information, upon receiving and during the analysis and diagnosis of the specimen. Each specimen is assigned a unique accession number and the accession number is entered into the LIS. Essentially all information relating to this specimen is associated with the accession number. The laboratory may also take one or more photomicrographs of the specimen or sections of the specimen. These photomicrographs are digitally stored on the same or a separate server in a format that is well known in the art and are identified by the accession number of the specimen. There also may be typical sketch-type outline graphic images of human physiological systems stored on this same or a separate server that are correlated to the specimen under analysis and are used to identify the location and severity of the specimen in a pathology report, for example there may be outline images of a prostate, a gastro-intestinal tract, and a cervical/gynecological image, among others. These outline images, if applicable, are associated with the specimen by information that is entered into the LIS.

Once the analysis and diagnosis of the specimen is complete at the laboratory, the information that is entered into the LIS is released by a pathologist responsible for the specimen. The LIS then creates a data file from the entered information which may contain, for example, information about the patient, the physician, the specimen, the outline image, and the diagnosis. This file is typically in a format that is useful for the transfer of health-related laboratory information.

The file created by the LIS is then communicated to a Interface/Communications Server. The Interface/Communications Server detects the presence of the file that has been transferred from the LIS. The Interface/Communications Server retrieves the information in the file that has been provided by the LIS and inserts formatting instructions into the data and saves the data along with the formatting instructions into a separate formatted file. The Interface/Communications Server also extracts some of the data that comprises the file that has been transferred from the LIS and transfers the data for storing on a cache server. Such extracted data may include, for example, a patient's name, date of birth, and social security number, the accession number, a level of significance code, a date the specimen was diagnosed, and the client/physician's name (collectively referred to as the “online viewing information”).

The Interface/Communications Server also detects the presence of this new formatted file containing the data transferred from the LIS and the formatting instructions. The Interface/Communications Server also determines if there are one or more photomicrographs and/or outline images associated with this specimen and, if so, retrieves these photomicrographs and/or outline images. The Interface/Communications Server then uses the formatting instructions and data in the new formatted file, along with any photomicrographs and/or outline images, and creates and stores a formatted image file for the specimen (a “pathology report file”) that that can be viewed over a web-based browser using common software as is well known in the art. This pathology report file is then transferred over a network to a web server where it is made available for viewing by the web-based browser.

When a client/physician connects to the web server through the use of a terminal or computer and via a network such as the Internet or a virtual private network, the client/physician logs into the web server using one or more passcodes associated with that client/physician. Upon logging in, an online viewing system application residing on the web server identifies pathology report files and associated online viewing information for specimens that have been submitted to the laboratory by that client/physician. The web server then retrieves from the cache server the online viewing information and displays all or some of the online viewing information for patients of the client/physician along with a link that will allow the client/physician to select and view the pathology report file for that patient. The online viewing system may cause the cache server to archive the online viewing information and pathology report files after they have been made available to the client/physician for a predetermined period of time.

When a client/physician connects and logs on to the web server through the online viewing system, the client/physician will be able to view the online viewing information and a link to the pathology report file for each specimen that the client/physician has submitted to the laboratory and that has been analyzed and diagnosed (and not archived). If the client/physician has submitted multiple specimens and they have been analyzed and diagnosed at the laboratory, then the client/physician will be able to view the online viewing information and links to the pathology report files for the many specimens, sort the online viewing information and the pathology report files based on diverse criteria, retrieve online diagnostic fact sheet associated with the diagnosis of the specimen, auto-requisition additional pathology tests, and print the results.

### BRIEF DESCRIPTION OF THE DRAWINGS

Having thus described the invention in general terms, reference will now be made to the accompanying drawings, which are not necessarily drawn to scale, and wherein:

FIG. 1 is a schematic block diagram of an exemplary system to generate a pathology report on a specimen and view the report online, in accordance with an embodiment of the present invention.

FIG. 2 is a flow chart illustrating an exemplary method to generate a pathology report, in accordance with an embodiment of the present invention.

FIG. 3 is a flow chart illustrating exemplary methods to view a pathology report online, in accordance with an embodiment of the present invention and to create, view online and print a diagnostic fact sheet that is associated with the diagnosis of a specimen, in accordance with an embodiment of the present invention.

FIG. 4 illustrates an exemplary user interface that is displayed when entering specimen and mapping information into the LIS in an embodiment of the invention.

FIG. 5 illustrates an exemplary user interface that is displayed when entering specimen and mapping information into the LIS in an embodiment of the invention.

FIG. 6 illustrates an exemplary user interface that is displayed when entering specimen and mapping information into the LIS in an embodiment of the invention.

FIG. 7 illustrates an exemplary user interface that is displayed when entering specimen and mapping information into the LIS in an embodiment of the invention.

FIG. 8 illustrates an exemplary user interface that is displayed when entering specimen and mapping information into the LIS in an embodiment of the invention.

FIG. 9 illustrates an exemplary user interface that is displayed upon successfully logging in to the system, whereby pathology report files for a client/physician are displayed for access by the client/physician in an embodiment of the invention.

FIG. 10 illustrates exemplary report status icons, whereby pathology report files for a client/physician are displayed for access by the client/physician in an embodiment of the invention and the status is indicated by icons for “new,” “reviewed,” or “printed” pathology report files.

FIG. 11 is an exemplary user interface for the selection of a diagnostic fact sheet by a client/physician from a drop-down menu where the diagnostic fact sheet is associated with the specialty of a client/physician submitting a specimen, the site of the specimen, and the severity of the diagnosis, in an embodiment of the invention.

FIG. 12 is an exemplary user interface for the automatic creation of a requisition by a client/physician for additional pathology tests on a sample or tests on a separate sample, where the requisition is automatically populated with client/physician and/or patient information, in an embodiment of the invention.

FIGS. 13A and 13B illustrate an exemplary pathology report file as prepared by an embodiment of the invention for a specimen located in the gastro-intestinal tract, all in accordance with an embodiment of the invention.

### DETAILED DESCRIPTION OF THE INVENTION

The present invention now will be described more fully hereinafter with reference to the accompanying drawings, in which preferred embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art. Like numbers refer to like elements throughout.

As will be appreciated by one skilled in the art, the present invention may be embodied as a method, a data processing system, or a computer program product. Accordingly, the present invention may take the form of an entirely hardware embodiment, an entirely software embodiment or an embodiment combining software and hardware aspects. Furthermore, the present invention may take the form of a computer program product on a computer-readable storage medium having computer-readable program code means embodied in the storage medium. More particularly, the present invention may take the form of web-implemented computer software. Any suitable computer-readable storage medium may be utilized including hard disks, CD-ROMs, optical storage devices, or magnetic storage devices.

The present invention is described below with reference to block diagrams and flowchart illustrations of methods, apparatuses (i.e., systems) and computer program products according to an embodiment of the invention. It will be understood that each block of the block diagrams and flowchart illustrations, and combinations of blocks in the block diagrams and flowchart illustrations, respectively, can be implemented by computer program instructions. These computer program instructions may be loaded onto a general purpose computer, special purpose computer, or other programmable data processing apparatus to produce a machine, such that the instructions which execute on the computer or other programmable data processing apparatus create means for implementing the functions specified in the flowchart block or blocks.

These computer program instructions may also be stored in a computer-readable memory that can direct a computer or other programmable data processing apparatus to function in a particular manner, such that the instructions stored in the computer-readable memory produce an article of manufacture including instruction means that implement the function specified in the flowchart block or blocks. The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified in the flowchart block or blocks.

Accordingly, blocks of the block diagrams and flowchart illustrations support combinations of means for performing the specified functions, combinations of steps for performing the specified functions and program instruction means for performing the specified functions. It will also be understood that each block of the block diagrams and flowchart illustrations, and combinations of blocks in the block diagrams and flowchart illustrations, can be implemented by special purpose hardware-based computer systems that perform the specified functions or steps, or combinations of special purpose hardware and computer instructions.

The present invention relates to systems and methods for the generation, online viewing, online severity indication, online sorting, and printing of pathology reports created by the analysis and diagnosis of tissue and organ specimens provided to pathology laboratories by client/physicians. The pathology reports may contain photomicrographs of the specimen as well as outline images of the physiological system from which the specimen was obtained. The report may indicate on the physiological system image the site from which the specimen was obtained and utilize a visual indicator to indicate the severity of the diagnosis of the specimen. The present invention also provides the automatic determination of a diagnostic fact sheet based at least partially on the site of the specimen, diagnosis of the specimen, and severity of the diagnosis, the online viewing of the diagnostic fact sheet, and the ability of the client/physician to print the diagnostic fact sheet for presentation to a patient. The present invention further relates to the auto-population of an online auto-requisition system with client/physician and patient information, the online viewing of the requisition, and the printing of the requisition by the client/physician.

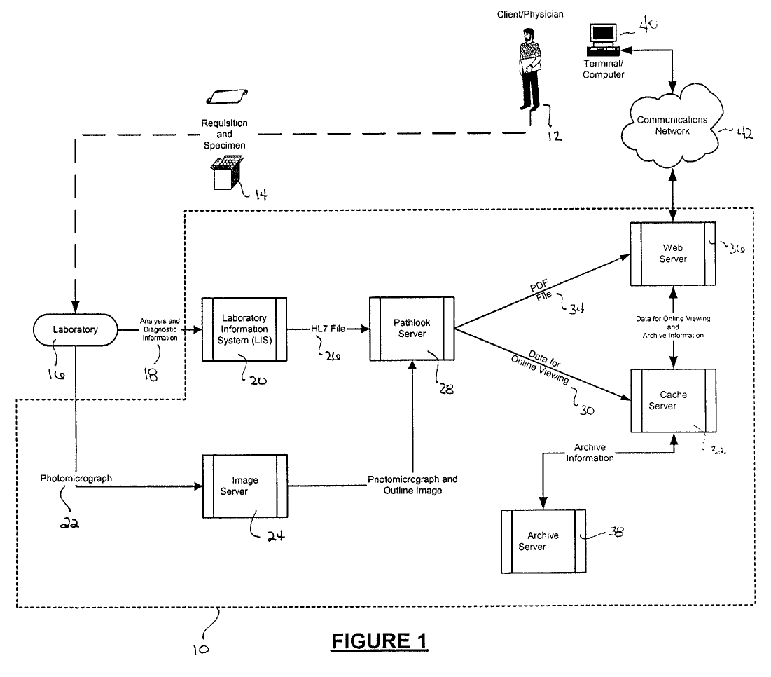

FIG. 1 is an illustrative overview of an exemplary system 10 to generate a pathology report on a specimen and view the report online, in accordance with an embodiment of the present invention. The exemplary system 10 illustrated in FIG. 1 comprises a specimen 14 that is provided to laboratory 16 for analysis and diagnosis; a laboratory information system (“LIS”) 20, whereby the laboratory 16 enters information 18 into the LIS 20 by methods which are well known in the art; an Interface/Communications Server (hereafter, the “Pathlook Server”) 28 to receive the data file from the LIS 20 and transform it into a formatted file 34 and to send online viewing information 30 to a cache server 32; and an archive server 38 for archiving online results. A terminal or computer 40 can be utilized to view the online results by accessing the web server 36 via a network 42 (e.g. Internet, virtual private network, etc.) and to print the online results, diagnostic fact sheets, reports, and requisitions via a printer (not shown). All of the servers, the LIS 20, and the terminal or computer 40 are connected to one another by a network such as Internet, Ethernet, telephone, a virtual private network, wireless, fiber optic, or by any other method or any combination.

The LIS 20 may be a commercially-available system such as, for example, the Antrim Laboratory System(as available from Antrim Corporation, a subsidiary of Sunquest Information Systems), the Chameleon Laboratory Information System (available from Laboratory Consulting, Inc.), the Hummingbird Laboratory Information Management System (also available from Laboratory Consulting, Inc.), or the Surge and WinSurge Pathology Laboratory Management Systems (available from Computer Trust Corporation, among others. The LIS 20 may also be software and systems that are developed internally by a pathology laboratory, or the LIS 20 may be a combination of commercially-available systems that have been customized for a laboratory. Information may be entered into the LIS by any number of means as are known in the art, including, for example, a keyboard, mouse or trackball, touch-screen, voice-recognition, scanning, data file transfer, etc. Generally, the LIS 20 will store the information that is entered into the LIS 20 in a hierarchical database on a server, such as the Pathlook Server 28.

The Pathlook Server 28, as well as any other server utilized in an embodiment of this invention, is a commercially available server such as one manufactured, for example, by International Business Machines Corporation (“IBM”), Sun Microsystems, Inc., NEC Computers, Inc., or Stratus Technologies, Inc. Applications resident on the Pathlook Server may be developed using commercially-available development platforms such as, for example, Delphi (as available from Borland Software Corporation), JAVA (available from Sun Microsystems, Inc.), or Visual Basic (available from Microsoft Corporation, Inc.).

The terminal or computer 40 is comprised of a display monitor; a processor for receiving, sending, processing, and/or displaying data, instructions and information; and interface means such as, for example, one or more of the following: a keyboard, a mouse, a track-ball, a voice recognition unit, a scanner, a touch-screen, a touch-pad, or by any other means of interacting with the terminal or computer 40, as are known in the art. The terminal or computer 40 may be solely dedicated to the exemplary system 10, or it may only be used as needed to access the exemplary system 10 and have other uses when not utilized to access the exemplary system 10. It may be manufactured by, for example, IBM, Compaq Computer Corporation (“Compaq”), Dell Computer Corporation, Gateway, Inc., or numerous other manufacturers. The terminal or computer 40 may also have an associated printer for printing pathology reports such as those manufactured, for example, by Lexmark International, Inc., Hewlett-Packard Company, Compaq, or others.

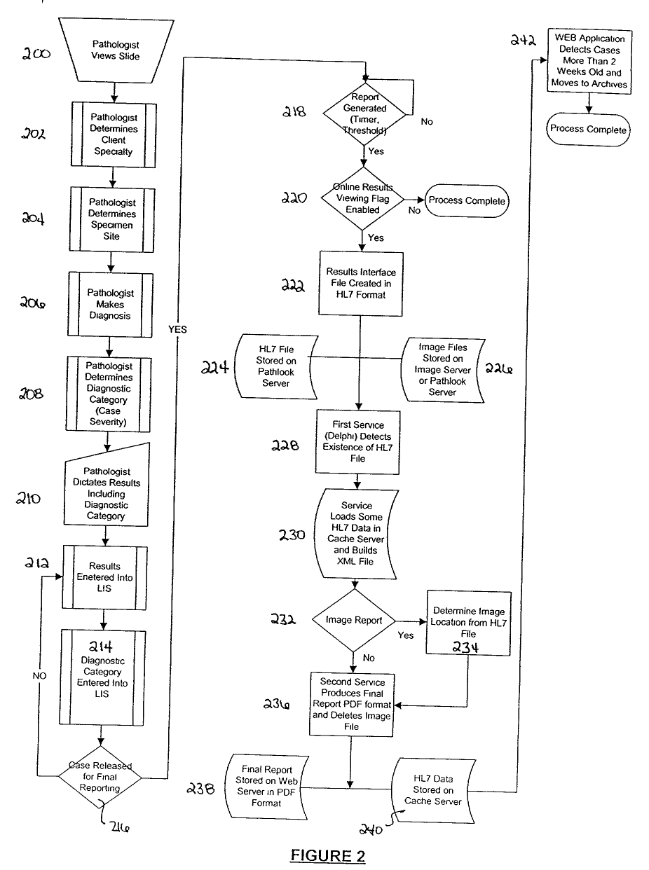

FIG. 2 is a flow chart illustrating an exemplary method to generate a pathology report, in accordance with an embodiment of the present invention. Referring now to FIGS. 1 and 2 and to other FIGS. as indicated, in Step 200 a client/physician 12 provides a patient's specimen 14 to a laboratory 16 for analysis and diagnosis and the specimen is reviewed by a pathologist. The pathologist determines the specialty of the client/physician (e.g., gastroenterology, obstetrics, urology, etc.) in Step 202. In Step 204 the pathologists determines the site of the human physiological system from which the specimen was obtained. In Step 206 the pathologist makes a diagnosis regarding the specimen. In Step 208 the pathologist determines a severity of the diagnosis (i.e., diagnostic category, such as “red” for carcinoma, “yellow” for dysplasia, and “green” for benign). In Step 210 the pathologist may transcribe the results of the analysis or provide them to another in some manner to be entered into the LIS 20, or the pathologist may themselves enter the information into the LIS. In Step 212 the information 18 concerning the specimen that has been received by the laboratory is entered into the LIS 20 upon receiving, during and after the analysis and diagnosis of the specimen 14. Each specimen 14 is assigned a unique accession number and the accession number is entered into the LIS 20. The accession number is utilized to identify information and data associated with the specimen. The laboratory may also take one or more photomicrographs 22 of the specimen 14 or sections of the specimen. The photomicrographs 22 are digitally stored on the same or a separate server 24 in any format suitable, and are identified by the accession number of the specimen 14.

There also may be typical sketch-type outline graphic images of human physiological systems stored on this same or a separate server 24 that are correlated to the specimen 14 under analysis by information entered into the LIS 20 and used to identify the location and severity of the specimen 14 in the resulting pathology report. For example, there may be outline images of a prostate, a gastro-intestinal tract, and a cervical/gynecological image, among others. Mapping information comprised of mapping codes is entered into the LIS 20 so that during compilation of a pathology report, these mapping codes allow the Pathlook Server 28 to obtain the proper outline image of the physiological system from which the specimen 14 was obtained, place the outline image on the pathology report, and place a visual indicator (e.g., a colored dot) over the approximate location on the outline image from which the specimen 14 was taken. The color of the visual indicator indicates a level of severity of the diagnosis of the specimen 14. For example, in an embodiment of the invention of a specimen taken from the gastro-intestinal tract, red may indicate “malignant,” orange may indicate “neoplasm benign or dysplasia,” yellow may indicate “inflammation,” and green may indicate “benign.” A key is placed on the pathology report during its compilation that correlates the colors of the visual indicator to the severity of the diagnosis.

In Step 212, information related to the patient, the client/physician 12, the specimen 14, a specimen site, the laboratory 16, a diagnosis (Step 214), a level of significance of the diagnosis, for example, is entered into the LIS 20. For example, in an embodiment of the invention, the information listed in Table 1 may be requested to be entered into the LIS 20, while Table 1 also provides exemplary sample information that may be entered into the LIS 20. In this embodiment, information entered into the LIS 20 includes, for example, the accession number, an account number, a patient ID, the requested pathological tests to be performed on the specimen, a patient's name, a patient's sex, a patient's age and date of birth (“dob”), notes and instructions regarding the specimen, the number of containers of the specimen, the patient's hospital or social security number, the physician requesting the analysis, the laboratory performing the analysis, a date the specimen was collected, a date the specimen was received by the laboratory, and miscellaneous name and address information. Furthermore, an embodiment of the invention may allow a pathology report on a specimen to be made available to persons other than the requesting physician. For example, as provided in Table 1, the accession number of the specimen along with identifying information (e.g., account number, account name, address, etc.) of others who are to have a pathology report for that specimen made available to them may be entered into the LIS 20.

TABLE 1

| Requested LIS Information | Sample Entered LIS Information |
|---|---|
| 1) Accession | D601 |
| 2) Account | PRI |
| 3) Patient ID | 23499 |
| 4) Test(s) | H;* |
| 5) Patient Name | TEST, JANE |
| 6) Sex | F |
| 7) Age, DOB | 37, 12/5/1963 |
| 8) Notes & Instruct. | RUSH CASE |
| 9) # Of Containers | 2 |
| 10) Hosp/SSN | 088-21-5555 |
| 11) Req. Phy. | DR S PRICE |
| 12) Physician UPIN # | 1234 |
| 13) Ref. Lab # | T01123 |
| 14) Date Spec Coll. | 11/28/2001 |
| 15) Date Spec Rec'd | 11/28/2001 |
| 16) Misc Name/Address | |
| Additional Report-To Client: | Y |
| Enter Additional Report-to Information | |
| 1) Accession | D601 |
| 2) Account | * |
| 3) Account Name | DR M JONES |
| 4) Address | 101 PINE ST |
| 5) | IRVING, TX 75384 |

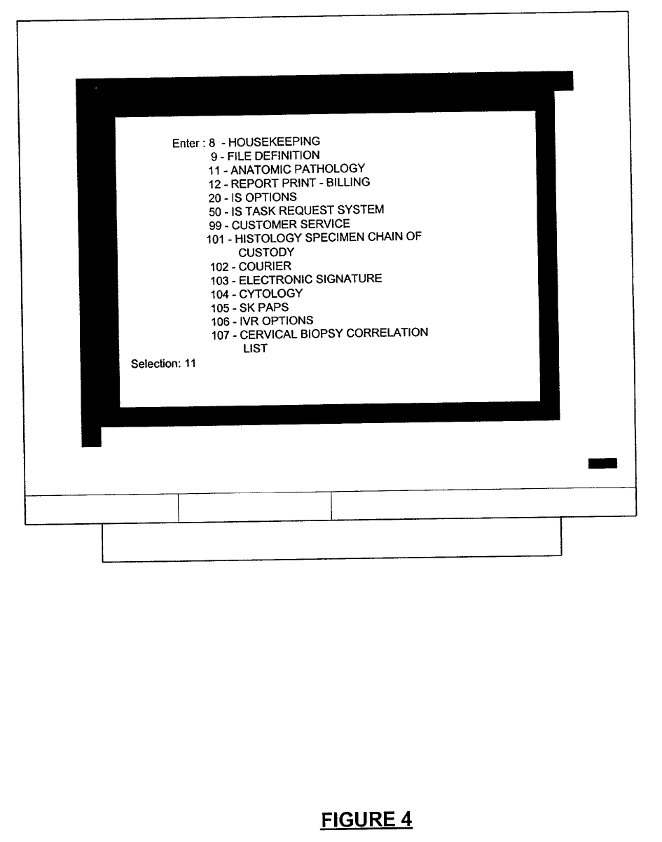

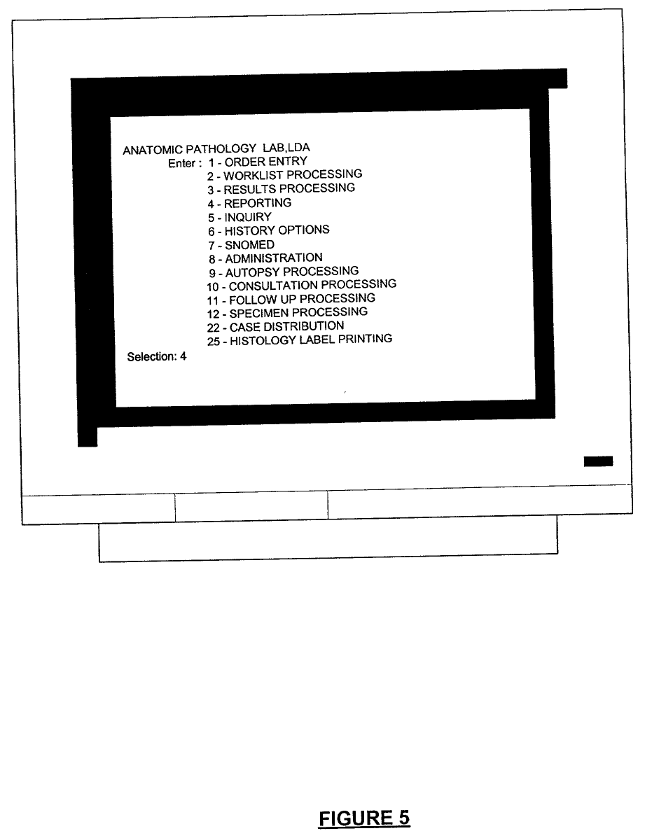

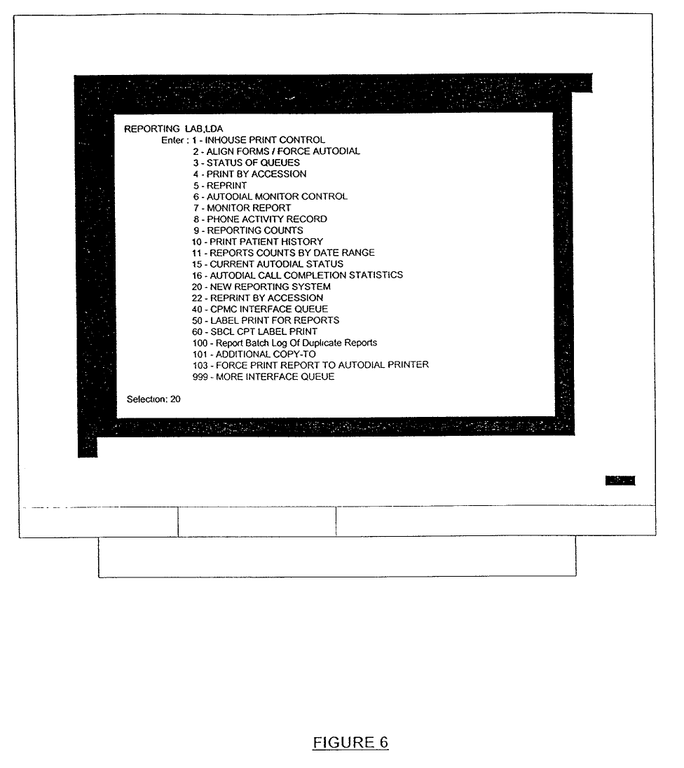

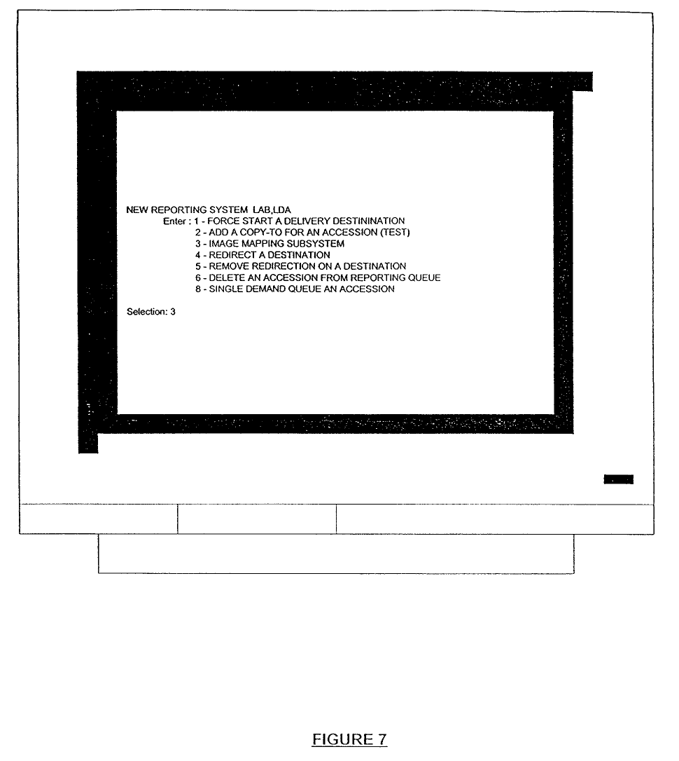

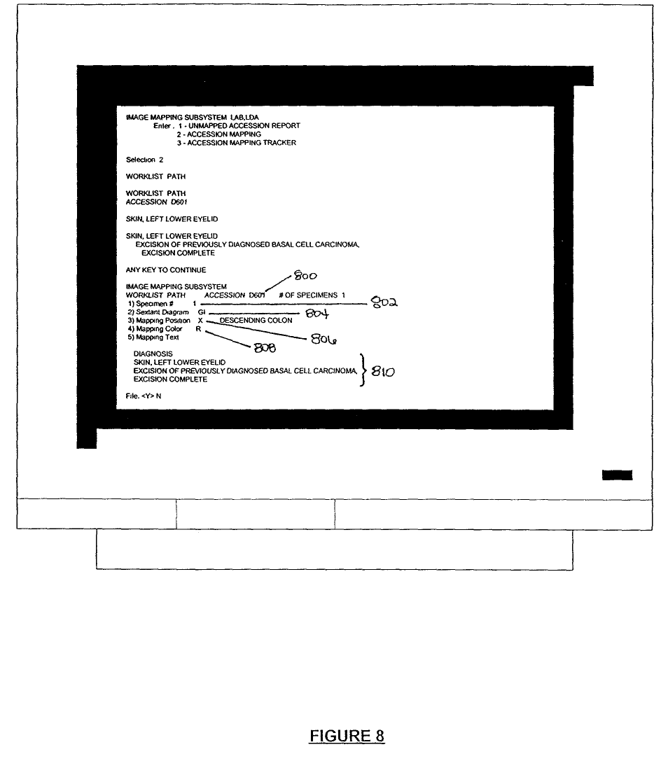

Mapping information is also entered into the LIS. FIGS. 4-8, for example, are illustrative of screens of the LIS 20 for entering mapping information in an embodiment of the invention. Mapping information is comprised of mapping codes that are entered into the LIS 20 which identify the physiological system (i.e., sextant diagram) from which the specimen 14 was obtained, the location (i.e., mapping site) of the specimen 14 within the identified physiological system, and a severity of the diagnosis (i.e., mapping colors) of the specimen 14. The entry of the mapping codes is indicated in FIG. 8, which includes, for example, the accession number 800, a specimen number 802, a mapping code for the sextant diagram 804, a mapping code for the mapping position 806, which indicates an approximate location on the sextant diagram from which the specimen was obtained, a mapping code for the mapping color 808 to visually indicate the severity of the diagnosis of the specimen, and text 810 that may be associated with the mapping of the location and severity of the specimen, in an embodiment of the invention. Tables 2-6 below, illustrate an exemplary embodiment of mapping codes that may be entered into the LIS 20 to identify an outline image or sextant diagram that corresponds to a specimen under diagnosis; mapping letter/number codes that may be entered into the laboratory information system to identify a location of the specimen on the outline image; and mapping color codes that may be entered into the laboratory information system to identify a result of the diagnosis of the specimen, in accordance with an embodiment of this invention. Table 2 provides exemplary diagram codes for sextant diagrams which provide an outline image of part, or all, of a human physiological system on a pathology report in an embodiment of the invention:

TABLE 2
Sextant Diagrams

| | Diagram |
|---|---|
| Type of Case | Code |
| GI | GI |
| Two-part prostate | 2PI |
| Four-part prostate | 4PI |
| Six-part prostate | 6PI |
| Twelve-part prostate | 12PI |
| Two-part transition zone | 2T |
| Four-part transition zone | 4T |
| Two-part seminal vesicle | 2S |
| Four-part seminal vesicle | 4S |
| Cervical punch biopsy + pap correlation image | CB1 |
| Cervical punch biopsy w/out pap correlation image | CB2 |
| Cervical biopsy (leep or cone) + pap correlation image | CB3 |
| Cervical biopsy (leep or cone) w/out pap correlation image | CB4 |
| Any other GYN specimen | CB5 |

Table 3 provides exemplary mapping codes that are entered into the LIS 20 to provide a visual location indicator at the approximate site on a gastro-intestinal (“GI”) outline image from which the specimen was obtained on a pathology report in an embodiment of the invention:

TABLE 3
GI Mapping Sites

| GI Site | Corresponding Mapping Code |
|---|---|
| Upper esophagus | A |
| Mid esophagus | B |
| Lower esophagus | C |
| EG junction | D |
| Cardia | E |
| Fundus | F |
| Body of stomach | G |
| Lesser curvature | H |
| Greater curvature | I |
| Antrum | J |
| Pylorus | K |
| Duodenum (upper) | L |
| Duodenum (lower) | M |
| Jejunum | N |
| Ileum | O |
| Terminal ileum | P |
| Ileocecal valve | Q |
| Cecum | R |
| Appendix | S |
| Ascending colon | T |
| Hepatic flexure | U |
| Transverse colon | V |
| Splenic flexure | W |
| Descending colon | X |
| Sigmoid colon | Y |
| Rectum | Z |
| Anus | AA |

Table 4 provides exemplary mapping codes that are entered into the LIS 20 to provide a visual location indicator at the approximate site on a prostate outline image from which the specimen was obtained on a pathology report in an embodiment of the invention:

TABLE 4
Prostate Mapping Sites

| Prostate Site | Corresponding Mapping Code |
|---|---|
| Left | A |
| Right | B |
| Left upper | C |
| Right upper | D |
| Left mid | E |
| Right mid | F |
| Left base | G |
| Left lateral base | H |
| Left mid | I |
| Left lateral mid | J |
| Left apex | K |
| Left lateral apex | L |
| Right base | M |
| Right lateral base | N |
| Right mid | O |
| Right lateral mid | P |
| Right apex | Q |
| Right lateral apex | R |
| Left seminal vesicle | S |
| Right seminal vesicle | T |
| Left lateral seminal vesicle | U |
| Right lateral seminal vesicle | V |
| Left transition zone | W |
| Right transition zone | X |
| Left lateral transition zone | Y |
| Right lateral transition zone | Z |

Table 5 provides exemplary mapping codes that are entered into the LIS 20 to provide a visual location indicator at the approximate site on a cervical/GYN outline image from which the specimen was obtained on a pathology report in an embodiment of the invention:

TABLE 5
Cervical/GYN Mapping Sites

| Cervical/GYN Site | Corresponding Mapping Code |
|---|---|
| 1:00 cervical biopsy | 1 |
| 2:00 cervical biopsy | 2 |
| 3:00 cervical biopsy | 3 |
| 4:00 cervical biopsy | 4 |
| 5:00 cervical biopsy | 5 |
| 6:00 cervical biopsy | 6 |
| 7:00 cervical biopsy | 7 |
| 8:00 cervical biopsy | 8 |
| 9:00 cervical biopsy | 9 |
| 10:00 cervical biopsy | 10 |
| 11:00 cervical biopsy | 11 |
| 12:00 cervical biopsy | 12 |
| Endocervical curettage | ECC |

Table 6 provides exemplary mapping codes for colors that are entered into the LIS 20 to provide a color for the visual location indicator at the approximate site on a prostate outline image from which the specimen was obtained on a pathology report in an embodiment of the invention, where such color indicates the severity of the diagnosis:

TABLE 6
Mapping Colors

| Type of Case | Corresponding Color Codes |
|---|---|
| GI | [R] Red |
| GI | [O] Orange |
| GI | [Y] Yellow |
| GI | [G] Green |
| Prostate | [R] Red |
| Prostate | [B] Black |
| Cervical/GYN | [R] Red |
| Cervical/GYN | [Y] Yellow |
| Cervical/GYN | [B] Blue |

In one embodiment, the outline images of the physiological systems associated with the sextant diagram codes (Table 2) may be stored as individual files on the Pathlook Server 28. In other embodiments, the outline images of the physiological systems associated with the sextant diagram codes (Table 2) may be stored as individual files on other servers, such as the image server 24. During compilation of a pathology report, the mapping codes allow the Pathlook Server 28 to obtain the proper outline image of the physiological system that is associated with the specimen 14 from the image server 24, or the Pathlook Server 28, place the outline image in the pathology report, place a visual indicator (e.g., a colored dot) over the location from which the specimen 14 was taken. The color of the visual indicator indicates a level of severity of the diagnosis of the specimen 14. For example, in an embodiment of the invention of a specimen taken from the gastro-intestinal tract, red may indicate “malignant,” orange may indicate “neoplasm benign or dysplasia,” yellow may indicate “inflammation,” and green may indicate “benign.” A key is placed on the pathology report during its compilation that correlates the colors of the visual indicator to the severity of the diagnosis.

Once the analysis and diagnosis of the specimen 14 is complete at the laboratory 16, in Step 216 of FIG. 2, the information that has been entered into the LIS 20 is released by a pathologist responsible for the specimen 14. In one embodiment of the invention, for example, the pathologist may release the information by an electronic signature. In Step 218, a timer for reporting and tracking purposes is set upon the release of a case for reporting. This timer will determine the time that elapses from when a case is released from reporting until commencing the compilation of the report. In Step 220, the LIS 20 determines if online reporting is enabled for this specimen. If so, the process continues, otherwise the online pathology report generation, in this embodiment, ends at this Step 220.

In Step 222 of FIG. 2, the LIS 20 then creates a data file 26 from the entered information 18. This file is typically in a format that is useful for the transfer of health-related laboratory information, such as a format recommended by HL7, as is illustrated for exemplary purposes in FIG. 1 in an embodiment of this invention. HL7 is an acronym for “Health Level Seven” and is one of several ANSI-accredited Standards Developing Organizations (“SDOs”) operating in the healthcare arena. Most SDOs produce standards (sometimes called specifications or protocols) for a particular healthcare domain such as pharmacy, medical devices, imaging or insurance (claims processing) transactions. Additional information concerning the HL7 standards and recommended formats can be found at the URL http://www.hl7.org.

In Step 224, the data file 26 created by the LIS 20 is communicated to the Pathlook Server 28 on which several applications reside. In Step 226, any images associated with the specimen, such as one or more photomicrographs, are communicated and stored on either the Pathlook Server 28 or another server. In Step 228, the Pathlook Server 28 detects the presence of the file 26 that has been transferred from the LIS 20. In Step 228, the Pathlook Server retrieves the information in the file 26 that has been provided by the LIS 20 and inserts formatting instructions into the data in a markup language for documents containing structured information such as, for example, HyperText Markup Language (“HTML”), Extensible Markup Language (“XML”), Standard Generalized Markup Language (“SGML”) or other markup languages and saves the data along with the formatting instructions into a separate formatted file on the Pathlook Server 28, in a file format such as HTML, XML, SGML or other.

In Step 230, the Pathlook Server 28 also extracts some of the data that comprises the data file 26 that has been transferred from the LIS 20, such extracted data may include, for example, a patient's name, date of birth, and social security number, the accession number, a specimen level of significance code, a date the specimen was diagnosed, and the client/physician's name (collectively referred to as the “online viewing information”) 30, and communicates this extracted data to the cache server 32, where it is stored (see Step 240). In an embodiment of the invention; the transfer of the online viewing information 30 to the cache server 32 may be made over a network via commercially available software such as, for example, ActiveX (as available from Microsoft Corporation), or others.

In Step 236, the Pathlook Server 28 then detects the presence of, for example, an HTML, XML, or SGML file, in this embodiment, that contains the data transferred from the LIS 20 and the formatting instructions. The Pathlook Server 28 also determines if there are one or more photomicrographs 22 and/or outline images associated with this specimen 14 (Step 232). Photomicrographs 22 are stored as separate files on a server and have file names the same as the accession number of the specimen 14. The Pathlook Server 28 is coded to look for an image file with the same accession number as the specimen 14 in a memory area of the Pathlook Server 28 or another server such as, for example, the image server 24, to determine if there are one or more photomicrographs 22 associated with the specimen 14. Outline images are stored as individual files on the Pathlook Server 28 or another server and the Pathlook Server determines if any sextant diagram codes (Table 2) have been entered into the LIS 20. If there are any photomicrographs 22 and/or outline images associated with the specimen 14, the Pathlook Server determines their location from coding (Step 234) and retrieves these photomicrographs 22 and/or outline images. In Step 236, the Pathlook Server then uses the formatting instructions and data in the new file along with any photomicrographs 22 and/or outline images and creates and stores a formatted image file for the specimen (a “pathology report file”) that that can be viewed via a web-based browser using common software as is well known in the art, such as pdf, HTML, etc. The pathology report file may also be transferred electronically such as, for example, through e-mail.

In Step 238, the pathology report file is then transferred over a network to the web server 36 so that it will be available for viewing by a web-based browser. In Step 242, if the pathology report file has been resident of the web server for a predetermined period of time (e.g. two weeks), the pathology report file moved from the web server 36 to an archive area/server 38 where it is stored. The predetermined amount of time that the pathology report is available for viewing on the web server 36 is adjustable through software. The process of creating a pathology report file for online viewing is then complete (Step 246) in the embodiment of the invention described in FIG. 2.

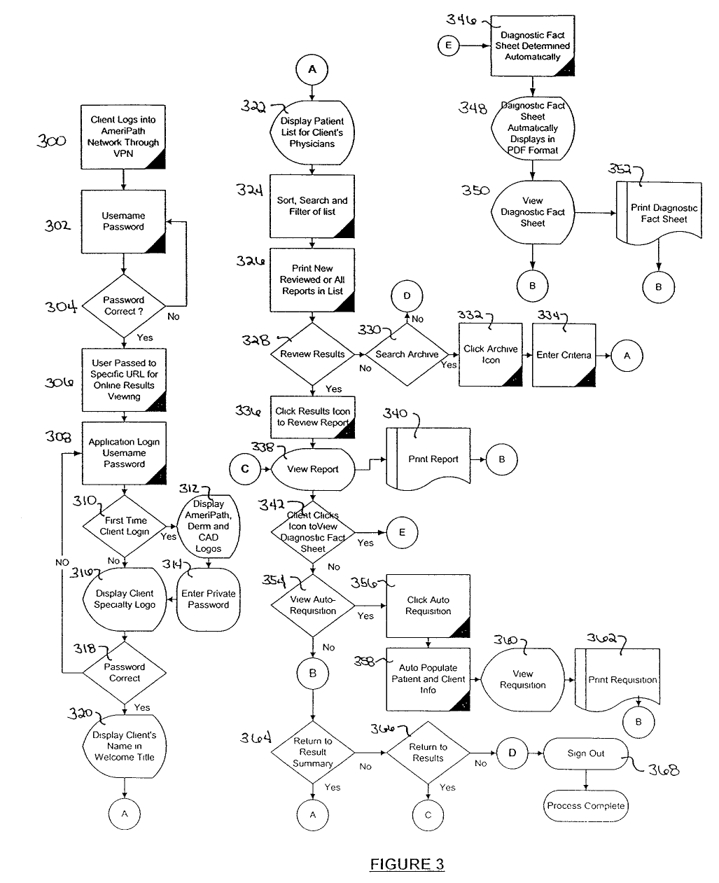

FIG. 3 is a flow chart illustrating an exemplary method to view a pathology report online, in accordance with an embodiment of the present invention. Referring now primarily to FIGS. 1 and 3, and other FIGS. where indicated, in Step 300 of FIG. 3 of this embodiment, when a client/physician connects to the web server through the use of a terminal or computer 40 and via a network such as the Internet or a virtual private network, the client/physician logs into the web server using one or more passcodes (Step 302) associated with that client/physician and gains access to an online viewing system. In Step 304, if the passcode is correct (Step 306), the client/physician is passed to a specific URL, depending upon the specialty of the client/physician. In Step 308, the client/physician then logs into a particular application through the use of one or more passcodes to gain access to the pathology reports of the client/physician's patients. In Steps 310, 312, and 314, if the client/physician is a first-time user, then a particular logo is displayed to the client/physician, depending upon the client/physician's specialty, and the client/physician is prompted to change their passcode. If the client/physician is not a first-time user, then the logo associated with that client's specialty is displayed in Step 316. The client/physician's passcode is checked in Step 318. If the client/physician has correctly entered their passcode, then the client/physician's name will be displayed in a welcome banner in Step 320, if not the correct passcode, the client/physician must re-enter their passcode (Step 308).

In an embodiment of this invention, the terminal or computer 40 used to view a pathology report online includes communications means for accessing and communicating with remote devices (i.e., a modem, or network card and associated software) and a web-browser application such as, for example, Microsoft Internet Explorer (as available from the Microsoft Corporation), Netscape Navigator (as is available from Netscape Communications Corporation, a subsidiary of AOL Time Warner, Inc.), or others.

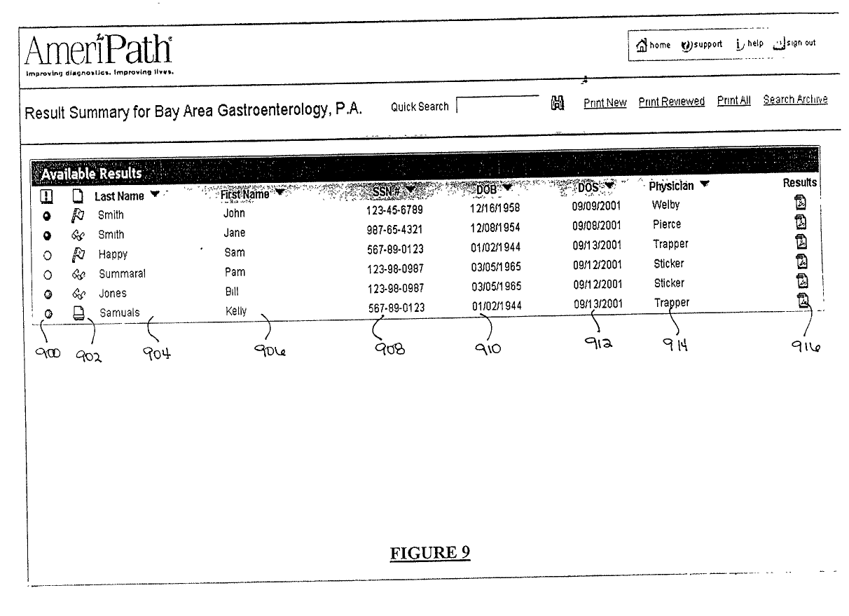

Upon logging in, an online viewing application residing on the web server 36, which is a part of an online viewing system, identifies pathology report files 34 and associated online viewing information 30 for specimens 14 that have been submitted to the laboratory 16 by that client/physician 12. In Step 322 of this embodiment of the invention, the web server 36 then retrieves from the cache server 32 the online viewing information 30 and displays all or some of the online viewing information 30 for patients of the client/physician 12 along with a link that will allow the client/physician 12 to select and view the pathology report file 34 for that patient. FIG. 9 is an exemplary illustration of a display of all or some of the online viewing information 30 for patients of the client/physician 12 along with a link that will allow the client/physician 12 to select and view the pathology report file 34 for that patient in an embodiment of the invention. The online viewing application may cause the cache server 32 to archive the online viewing information 30 and pathology report files 34 after they have been made available to the client/physician 12 for a certain amount of time.

When a client/physician 12 connects and logs on to the web server 36 through the online viewing system, the client/physician 12 will have access to view the online viewing information 30 and a link to the pathology report file 34 for each specimen 14 that the client/physician 12 has submitted to the laboratory and that has been analyzed and diagnosed (but not archived). If the client/physician 12 has submitted multiple specimens 14 and they have been analyzed and diagnosed at the laboratory 16, then the client/physician 12 will be able to view the online viewing information 30 and links to the pathology report files 34 for the many specimens 14. The online viewing information 30 and the pathology report file 34 associated with that online viewing information, as accessed through the link in the online viewing system, are collectively known as the online results. FIG. 9 provides an exemplary view of the display of online results in an embodiment of the invention illustrating online viewing information comprised of the fields of level of severity indicator 900, status (new, reviewed, or printed) 902, patient's last name 904, patient's first name 906, patient's social security number 908, patient's date of birth 910, a data of service (date the pathology analysis was conducted) 912, the requesting physician's name 914, and a link 916 to the pathology report file, for each specimen provided by the client physician (e.g., “Bay Area Gastroenterology, P.A.,” in FIG. 9).

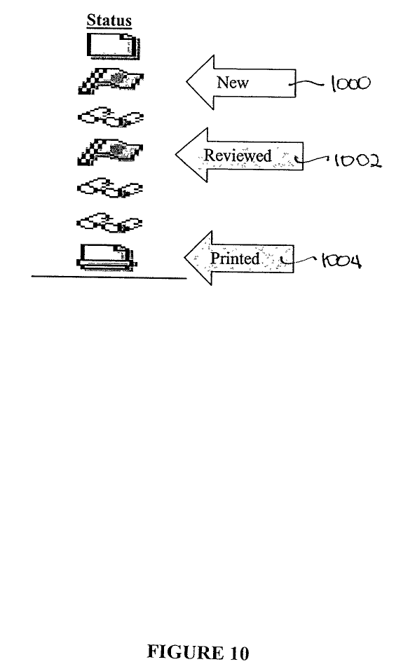

In Step 324 of FIG. 3 in this embodiment, the online viewing application may sort the online results by a level of significance of the diagnosis. For example, in an embodiment the online results may have a color indicator for the level of significance such as red for severe illness or need of medical attention, yellow for a standard displaysia diagnosis, and green for a benign diagnosis. This level of significance may be indicated by a colored dot in a field (e.g., the field 900 with an exclamation mark “!” in its header as depicted in FIG. 9) on the online viewing system screen or it may be indicated by the color of other fields of the online viewing information 30 or link to the pathology report file 34. In other embodiments the level of significance may be indicated by symbols, codes, letters, numbers, flashing or any other method of alerting the client/physician as to the level of significance of the diagnosis of the specimen. All the specimens 14 with a red status will be listed first or at the top of the online viewing system, those with a yellow status next after those with red status, and those with a green status last. The online viewing system may also allow the client/physician 12 to sort any of the online viewing information 30 that is displayed by the online viewing system by any of the fields that are displayed, such as by the level of significance, the patient's name or the date the specimen was diagnosed. For example, the client/physician 12 may be able to sort the information by the patients'last names, either ascending or descending. The client/physician 12 may also be able to create custom sorts, for example by finding all specimens 14 that were diagnosed between Jan. 1, 2002 and Jan. 31, 2002. Some sorts may only sort online results within their level of significance group, for example the online viewing system may sort all specimens 14 by the status column (e.g., new, reviewed or printed) within the level of significance group, meaning that the cases with the most severe diagnoses (e.g., red) stay at the top of the screen of the online viewing system and are sorted by the selected status. The reports with the non-selected statuses that also have the most severe diagnosis will follow. Likewise, all the online results with yellow and green levels of significance status will remain grouped together; however they will be sorted by status within their level of significance group. FIG. 10 depicts, for example, the status field 902 of FIG. 9 and illustrative icons used to indicate the status of new 1000, reviewed 1002, or printed 1004, in an embodiment of the invention.

In Step 326 the online results viewing system may also allow the client/physician the ability to print all pathology report files 34 that have a certain status (e.g., new or reviewed). For example, the client/physician may selectively choose to print all pathology report files 34 with the status of “new,” which means that these pathology report files 34 have not previously been reviewed by the client/physician. Likewise, the client/physician may selectively choose to print all pathology report files 34 with a status of “reviewed,” which includes all pathology report files 34 that have previously been reviewed by the client/physician, or, the client/physician may choose to print all pathology report files 34 that are displayed.

In Step 328, the client/physician 12 may review online results by either searching (Steps 330, 332, and 334) the archives for certain online results that have been archived and then retrieving archived online results or the client/physician 12 may in Step 336 select a link that is displayed in the online results to (Step 338) view a pathology report file 34, with the option to print it (Step 340). The client/physician 12 also may have the ability to run various reports on the online results associated with that client/physician.

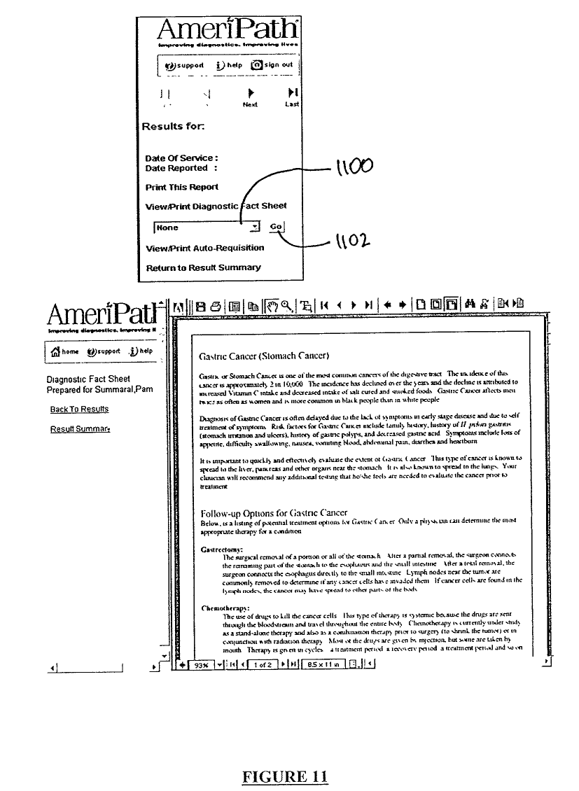

Step 342, and as depicted in exemplary FIG. 11 in an embodiment of the invention, allows a client/physician to view online a diagnostic fact sheet that is associated with the diagnosis of a specimen, in accordance with an embodiment of the present invention. In one embodiment, and as depicted in exemplary FIG. 11, the client/physician selectively chooses a diagnostic fact sheet associated with one or more of the specialty of the client/physician, the site of the specimen, or the severity of the diagnosis from a drop-down menu 1100 and then retrieves the selected diagnostic fact sheet 1102. In other embodiments of the invention and as stated in Step 346, the diagnostic fact sheet is automatically determined by the online results viewing system from one or more of the specialty of the client/physician, the site of the specimen, and the severity of the diagnosis. The diagnostic fact sheet may be accessed through one or more of a drop down menu 1100 from the user interface of the system that is shown in FIG. 9, selecting a link that is displayed in the online results, or by selecting a link in the pathology report file 34. The diagnostic fact sheet may be viewed online in a printable format (such as PDF, HTML, etc.) or it may be printed. Diagnostic fact sheets may be stored as individual files archived on the web server 36 or the cache server 32, or they may be dynamically compiled from archived textual and graphical information for a specimen 14 either automatically or when an action has been taken by a user to access a diagnostic fact sheet associated with a specimen 14. Diagnostic fact sheets may contain textual and/or graphical information and they may contain information specific to one or more of the patient, the client/physician 12, the system 10, or the specimen. The diagnostic fact sheet will provide helpful information regarding the diagnosis to the client/physician 12 and the patient and may be automatically displayed in Step 348 once the diagnostic fact sheet has been determined by the specialty of the client/physician, the site of the specimen, and the severity of the diagnosis. The client/physician may then view the diagnostic fact sheet on-line (Step 350) and selectively choose to print the diagnostic fact sheet (Step 352).

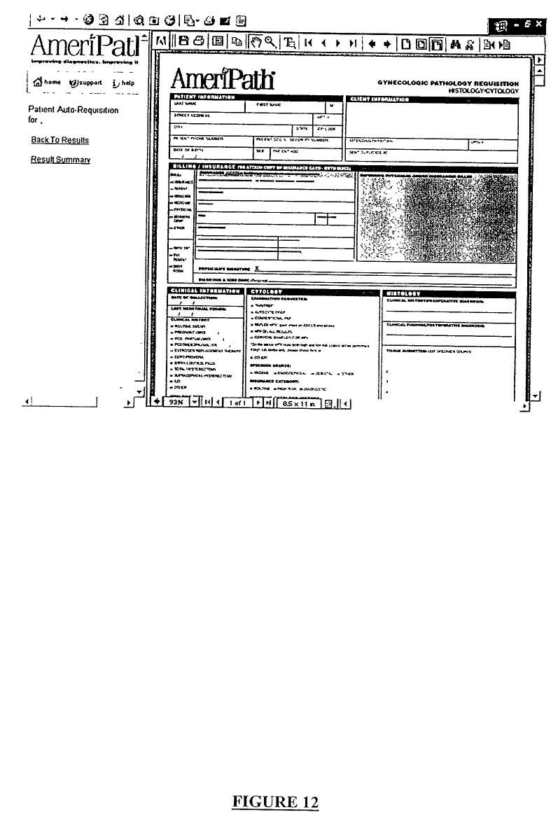

In Step 354 of this embodiment depicted in FIG. 3, the online viewing system may also allow a client/physician 12 to auto-populate a requisition form for additional pathological tests on the same or a different specimen with patient and client/physician information that can be sent to the laboratory 16. In Step 356 and as depicted in exemplary FIG. 12 in an embodiment of the invention, the client/physician selectively chooses an icon to create an auto-requisition form. In Step 358, the auto-requisition form may be auto-populated by having information pertaining to the client/physician and the patient automatically inserted into the form. Such information is obtained from the cache server 32 and may be comprised of, for example, the client/physician's name and address and the patient's name, address and social security number. In Step 360, the client/physician may view the requisition on-line and correct existing information or add additional information. In Step 362, the client may print the requisition.

In Steps 364 and Steps 366, the system provides the client/physician to return to certain screen of the online results viewing system to view other online results or to further review a pathology report file. If the client/physician does not want to further review online results or a pathology report file, they may exit the system at Step 368.

The online results viewing system may allow the client/physician 12 to print locally one or all of the online results, the online viewing information 30, the pathology report file 34, the auto-requisition, various reports as requested by the client/physician, and diagnostic fact sheets.

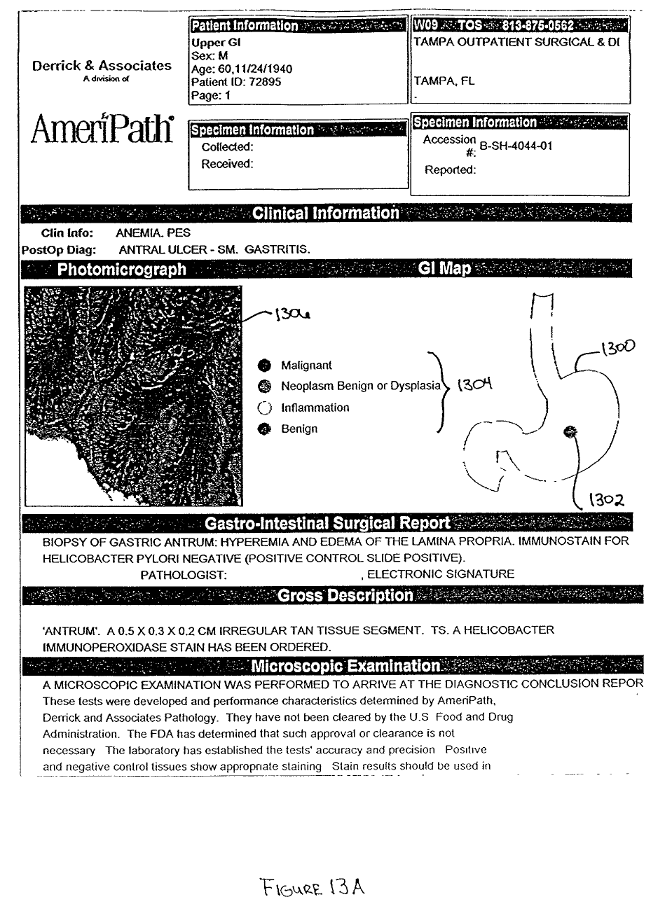

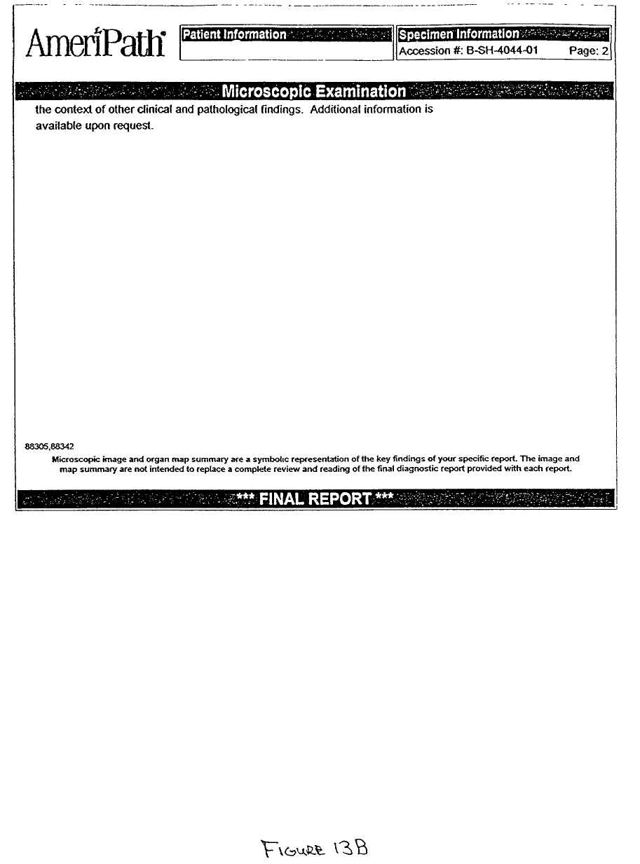

FIGS. 13A and 13B illustrate an embodiment of a pathology report file 34 for a specimen taken in a gastro-intestinal tract. The specimen 14 analyzed in this report was taken from an area of the stomach and the results were benign. A sextant diagram 1300 of a portion of the physiological system of the gastro-intestinal tract is shown in this embodiment along with a colored dot 1302 that indicates the approximate location from which the specimen was obtained as well as the severity of the diagnosis (as indicated by the color of the dot 1302 and the key 1304 that is provided in the pathology report file 34). Also shown in this embodiment is a photomicrograph 1306 of the specimen.

Many modifications and other embodiments of the invention will come to mind to one skilled in the art to which this invention pertains having the benefit of the teachings presented in the foregoing descriptions and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. A system for creating pathology reports on tissue and organ specimens provided to a pathology laboratory by a client/physician comprising:
at least one outline image of a human physiological system;
a laboratory information program that receives textual and/or graphical information associated with a pathological analysis of a tissue or organ specimen and generates a data file based at least partially thereon; and
a software application that generates a formatting file based at least in part on the contents of the data file, wherein the formatting file includes formatting instructions for formatting a pathological report, and generates the pathological report according to the formatting instructions and based at least partially on the formatting file and outline images, wherein the pathological report includes a visual indicator on the outline image that identifies a location that indicates an approximate location from which the organ or tissue specimen was obtained and a severity of a diagnosis of the specimen.

2. The system of claim 1, further comprising at least one photomicrographs of the tissue or organ specimen, wherein the software application generates the pathological report based at least partially on formatting file, one or more of the outline images and the photomicrographs.

3. A system for viewing a pathology report, comprising:
a database including pathological analysis data and related patient data associated with a pathological specimen, and further including an image file comprising a pathological report associated with the specimen;
a web server in communication with the database and that generates an online viewing results web page based at least partially on the pathological analysis data and related patient data associated with a pathological specimen stored on the database, wherein the online viewing result web page provides access to the image file.

4. The system of claim 3, wherein the pathological analysis data includes diagnosis information related to a location within a physiological system from which the specimen was taken and severity of the diagnosis.

5. A method for creating a pathology report on tissue and organ specimens provided to a pathology laboratory by a client/physician, comprising:
storing outline images of one or more human physiological systems as image files;
receiving textual and/or graphical information associated with a tissue or organ specimen, the textual and/or graphical information including a diagnosis, diagnosis severity information, and site information indicating a location of the organ or tissue sample into an information system software program;
generating a data file based on the textual and/or graphical information associated with the tissue or organ specimen;
generating a formatting file based at least partially on the data file, wherein the formatting file includes formatting instructions for use in generating a pathological report;
generating a pathology report based on at least the formatting file and one or more of the outline images and formatting the pathological report according to the formatting instructions, wherein the pathological report includes a visual indicator on the outline image at a location that indicates an approximate location from which the organ or tissue specimen was obtained and the severity of the diagnosis of the specimen.
